(19) United States
(12) Patent Application Publication
(10) Pub. No.: US 2019/0072392 A1
(43) Pub. Date: Mar. 7, 2019

(54) SYSTEM AND METHOD FOR SELF-GEOPOSITION UNMANNED AERIAL VEHICLE

(71) Applicants: MITCHELL MOSHE HASPEL, JERUSALEM (IL); SHLOMO HAHIM, KFAR YONA (IL)

(72) Inventors: MITCHELL MOSHE HASPEL, JERUSALEM (IL); SHLOMO HAHIM, KFAR YONA (IL)

(21) Appl. No.: 15/755,640

(22) PCT Filed: Aug. 25, 2016
(86) PCT No.: PCT/IL2016/050934

§ 371 Date: Feb. 27, 2018

(30) Foreign Application Priority Data
Sep. 6, 2015 (IL) 241200

(51) Int. Cl. G01C 21/20

(52) U.S. Cl. CPC G01C 21/20; G01S 5/16

(57) ABSTRACT

A system for self-geoposition an unmanned aerial vehicle (UAV), the system includes a memory for storing an accurate map data and/or an aerial photography of a ground region. A camera is mounted on the UAV and is able to record in real time or during the UAV flight images and streaming video that is stored in the memory. A landmarks/objects correlation module uses methods and techniques for identification and association/correlation of objects/landmarks optically detected on the field-of-view (FOV) of the camera, with objects/landmarks in the aerial photography region. Angles differences measuring module, measures included/inscribed angles within the camera's FOV by counting pixels in the image of the camera to find the included angles of pairs of landmarks in respect to the camera. A camera geo-position calculation module calculates the self geo-position of the UAV by using the landmarks position and the included/inscribed angles. A display is used to display the landmarks and the calculated current position/coordinates of the UAV on a map data and/or on aerial map/photography of the ground region.

### FIELD OF THE INVENTION

The present invention relates to self-geoposition of an unmanned aerial vehicle (UAV), in particular self-geoposition of a UAV without the use of Global Positioning System (GPS).

### BACKGROUND OF THE INVENTION

In terrain navigation, the global position of an airborne camera system and its orientation are usually measured through onboard GPS and INS sensors. However, there are circumstances where the position and direction given by the GPS and INS sensors are not accurate due to built-in errors, poor signal to noise ratio, intentional R-F jamming, or faulty operation of the sensors. In such cases, video images of known landmarks can be used to perform visual navigation, hence compensate the GPS and INS errors and dysfunctions.

Such issues are addressed for example in the article of Guna Seetharman and Ha V.Le “Video-Assisted Global Position in Terrain Navigation With Known Landmarks”, International Journal of Distributed Sensor Networks, 2: 103-119,2006, incorporated herein by reference.

KR20120116202 discloses a location recognition method using a portable terminal and apparatus thereof to effectively recognize a current location by capturing markers using a camera attached to the portable terminal. The system includes a marker image acquisition unit acquires the image of markers using a plurality of cameras mounted in the portable terminal. A distance computation unit respectively computes a distance between the portable terminal and each marker from the acquired image. An intersection point acquisition unit acquires intersection points where virtual circles or spheres are crossed from each other based on each marker. A location computation unit computes the location information of the intersection point based on the location information for one or more markers.

WO2013186989 describes movement-measurement-processing system capable of identifying a peripheral device for which there is a possibility of abnormally nearing a device of interest. For each pair of interval information sets, a peripheral-device sorting means uses a first projection matrix and maps, on a 2D plane, a region inside a 3D space defined by: a starting point for the interval information of the device of interest, a point having as coordinates the passing-position coordinates at the ending point of the interval information, and the lower-limit arrival time. A point having as coordinates the passing-position coordinates at the ending point of the interval information, and the upper-limit arrival time. The peripheral-device sorting means sorts the peripheral devices for which there is a possibility of abnormally nearing a device of interest, by performing an intersect determination between the obtained region and a circle, the radius of which is the threshold that is the determination reference for the occurrence or lack thereof of an abnormal nearing, and the center of which is the passing position of the peripheral device.

U.S. Pat. No. 5,477,459 described a method and system for locating the point P0 which defines the location of a machine, e.g. an earth moving machine, a surveying or locating machine, etc., in relation to a tract or area of interest by measuring the angles defined by two different sets of reference points selected from at least three reference points that are in known relation to the tract or area.

One of the objects of the present invention is to provide a method to self-geoposition a UAV without the use of GPS.

Another object of the present invention is to provide the self-geopostion of a UAV by requiring only the ground position of the UAV, that is, the projection of the UAV 3-dimensional position with respect for example to the earth coordinates, on the ground, in latitude-longitude or with respect to the Universal Transverse Mercator (UTM) coordinates system.

Another object of the present invention is to provide the self-geopostion of a UAV without the use of GPS and where the altitude is not required to be found accurately.

Yet another object of the present invention is to provide the self-geopostion of the UAV without the use of GPS and to obtain circular error probable (CEP) accuracy as good or better as those normally found from use of GPS, which is approximately 6 meters, under proper conditions of geometry and resultant included angle standard deviation.

### SUMMARY OF THE INVENTION

The present invention relates to self-geoposition of an unmanned aerial vehicle (UAV), in particular self-geoposition of a UAV without the use of Global Positioning System (GPS).

In accordance with an embodiment of the present invention there is provided a system for self-geoposition an unmanned aerial vehicle (UAV), the system includes a memory for storing an accurate map data and/or an aerial photography of a ground region. A camera is mounted on the UAV and is able to record in real time or during the UAV flight images and streaming video that is stored in the memory. A landmarks/objects correlation module uses methods and techniques for identification and association/correlation of objects/landmarks optically detected on the field-of-view (FOV) of the camera, with objects/landmarks in the aerial photography region. Angles differences measuring module, measures included/inscribed angles within the camera's FOV by counting pixels in the image of the camera to find the included angles of pairs of landmarks in respect to the camera. A camera geo-position calculation module calculates the self geo-position of the UAV by using the landmarks position and the included/inscribed angles. A display is used to display the landmarks and the calculated current position/coordinates of the UAV on a map data and/or on aerial map/photography of the ground region.

### BRIEF DESCRIPTION OF THE DRAWINGS

The invention may be understood upon reading of the following detailed description of non-limiting exemplary embodiments thereof, with reference to the following drawings, in which:

FIG. 1 is a schematic block diagram of the system in accordance with some embodiments of the present invention;

FIG. 2 is a schematic diagram illustrating schematically field of view (FOV) of a camera, landmarks that are within the camera's FOV and landmarks that are not in the camera's FOV;

FIG. 3 is a schematic diagram illustrating the camera included angle in respect to two landmarks points and a circle that designates the possible position of the camera;

FIG. 4 is a schematic diagram illustrating geometrically how to find in accordance of the present invention the position of a camera by knowing for example the ground position of three landmarks;

FIG. 5 is a schematic diagram illustrating geometrically how to find in accordance of the present invention the position of a camera by knowing for example the ground position of four landmarks; and

FIG. 6 is a flow chart describing the method for finding the global position of a UAV in accordance with some embodiments of the present invention.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS OF THE INVENTION

In accordance with the present invention there is provided a system and method for computing the global position of a UAV without the need of GPS.

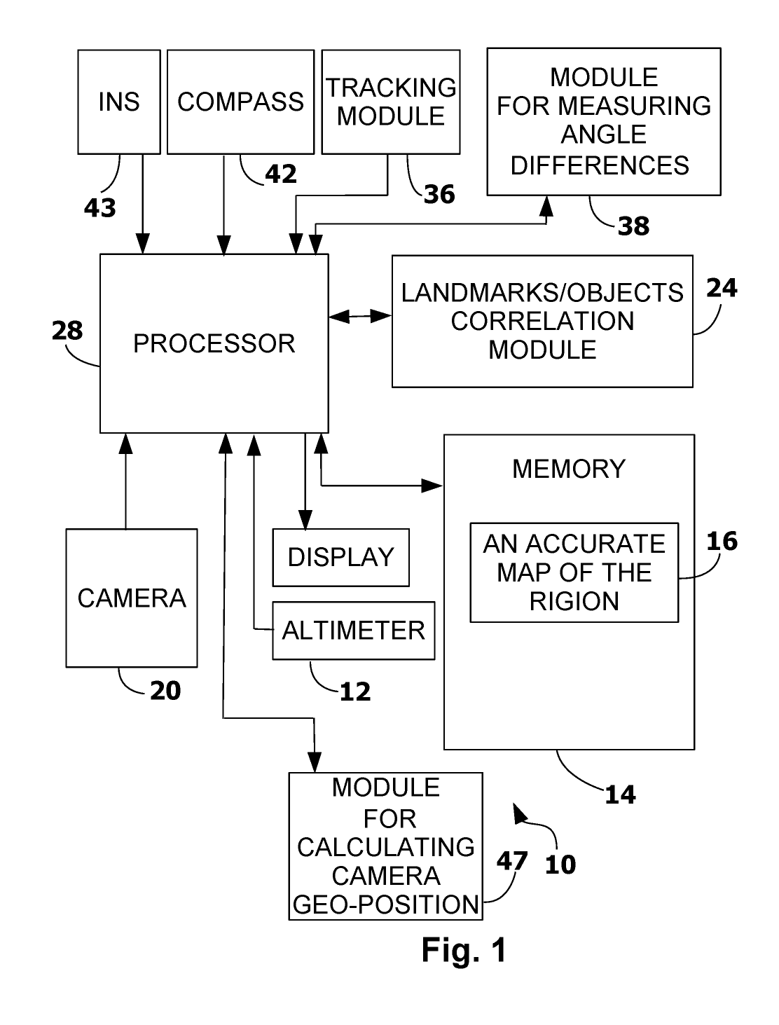

Referring first to FIG. 1, there is shown a schematic block diagram of a system 10 for self-geoposition of an unmanned aerial vehicle (UAV) in accordance with some embodiments of the present invention. The system 10 may include an altimeter 12 to measure the altitude of the UAV for example above a fixed level. The system 10 further includes a memory 14 for storing an accurate map data and/or an aerial photography of the ground region from an elevated position 16. The system further includes a camera 20 that is mounted on the UAV and is able to record in real time or during the UAV flight images and streaming video that can be stored in the memory 14. In some embodiments of the present invention the camera records can be also transmitted to another location such as but not limited to a ground control station. These images may be still photographs or moving images such as videos or movies.

The system 10 further includes landmarks/objects correlation module 24 which uses methods and techniques for identification and association/correlation of objects/landmarks seen on the field-of-view (FOV) of the camera 20, with objects/landmarks on an accurate map. The methods and techniques for identification and association/correlation of objects/landmarks seen on the field-of-view (FOV) of the camera 20 may be similar to orthophotography. The module can therefore find the coordinates of every point of interest landmark in the camera FOV by comparison with the accurate map, referred to ground level. This may also contribute some error to the process of self-geoposition of the UAV. Correlation of landmarks, appearing in the video image, with landmarks appearing on the relevant map, may be accomplished by means of available registration software.

Orthophotographs are commonly used in the creation of a Geographic Information System (GIS). Software can display the orthophoto and allow an operator to digitize or place linework, text annotations or geographic symbols. Some software can process the orthophoto and produce the linework automatically. An orthophoto, orthophotograph or orthoimage is an aerial photograph geometrically corrected (“orthorectified”) such that the scale is uniform: the photo has the same lack of distortion as a map. Unlike an uncorrected aerial photograph, an orthophotograph can be used to measure true distances, because it is an accurate representation of the Earth's surface, having been adjusted for topographic relief, lens distortion, and camera tilt.

The term “module” described here in the specification imply a unit of processing a predetermined function(s) or operation(s) and can be implemented by hardware or software or a combination of hardware and software. Software codes may be stored in the memory 14 and driven by a processor 28. The memory unit 14 is positioned inside or outside of the processor to transmit and receive data to and from the processor by various known means.

The angle differences measuring module 38, measures included/inscribed angles preferably within the camera's FOV by counting pixels in the image to find the included angles of two landmarks in respect to the camera. When two lines meet at a common point (vertex) the angle between them is called the included angle. If the included angles are measured by scanning the camera then there will be required to obtain the angles when the camera is pointing to a specific region and then to rotate the camera to a new pointing angle and re-measure. This process will introduce error due to the rotation process even though in the end the difference of the angles is taken. Thus, the pixel count used to find the included angles must account for the orientation of the camera lens in order to find the proper angle parallel to the horizon.

If the rotation of the camera is not required, there is some distortion of the image to be expected in going from camera image to map, such as due to the camera lens, but this distortion is known in advance and can be compensated for by use of a loop-up table, for example. In general, in accordance of the present invention the angle differences measurements are made at the same time so there is no UAV motion to compensate. The method depends on the measurement of angular differences, included angles, not on the absolute values on the ground projection. Therefore, systematic errors are expected to be mostly canceled. In addition, random angular error effects are expected to be reduced significantly for the same reason.

For the no rotation of the camera requirement, the landmarks lay within the FOV, for example a FOV of 45°. In general, landmarks with wider angular spacing, give better results. If a wider FOV is required for accuracy, mounting a wider FOV lens, or fish-eye lens, or two camera lenses at a permanent fixed angle to obtain a wider FOV can be considered.

The included angles are to be measured in the plane of the flat earth model, that is, parallel to the surface of the earth, in the 2D geometry. This may be found from the 3D angles by transformations and sensors. However, it may be useful to mount a camera on the UAV which is kept level with the horizon using gyroscopes as an aid in directly measuring these angles. Thus, the system 10 may further include camera gimbal mount, not shown, to allow the camera to remain upright with respect to the horizon despite the UAV's pitching and rolling.

The system 10 further includes a camera geo-position calculation module 47 for calculating the self geo-position of the UAV. Detailed description of how to calculate the self geo-position of the UAV will described later below.

Other onboard navigation equipment may be used to remove ambiguities and improve accuracy including fusing of data. Thus, the system may further include a compass 42 that shows direction relative to the geographic cardinal directions. Since the azimuth differences are used, the true direction of north is not of importance—thus errors in the compass readings due for example to electric motor disturbances and offsets will be less important, as long as the measurement is done while the compass is constant. There is no need to measure ranges to targets in the system described, only included angles.

To reduce error and increase accuracy of the camera position the system may further include a navigation aid such as an inertial navigation system (INS) 43 that uses a computer, motion sensors (accelerometers) and rotation sensors (gyroscopes) to continuously calculate via dead reckoning the position, orientation, and velocity (direction and speed of movement) of the camera. The system may further include Kalman filter module or any suitable tracking module 36 to improve accuracy by using past history of the flight. Motion of the UAV can be used to reduce error and remove ambiguity.

The system may further include a display 45 to display for example the landmarks and the calculated position/Coordinates of the UAV on a map data and/or on aerial map/photography of the ground region.

Those of ordinary skill in the art will appreciate that the hardware depicted in FIG. 1 is a basic illustration of the system 10, and thus the hardware utilized in actual implementation may vary. Thus, the depicted example is not meant to imply architectural limitations with respect to the present invention. Notably, in addition to the above described hardware components of system 10, various features of the invention are completed via software (or firmware) code or logic stored within memory 14 and executed by processor 28. Thus, in the case of implementation by firmware or software, the method according to the exemplary embodiments of the present invention may be implemented in the form of a module, a process, or a function of performing the functions or operations described in this application.

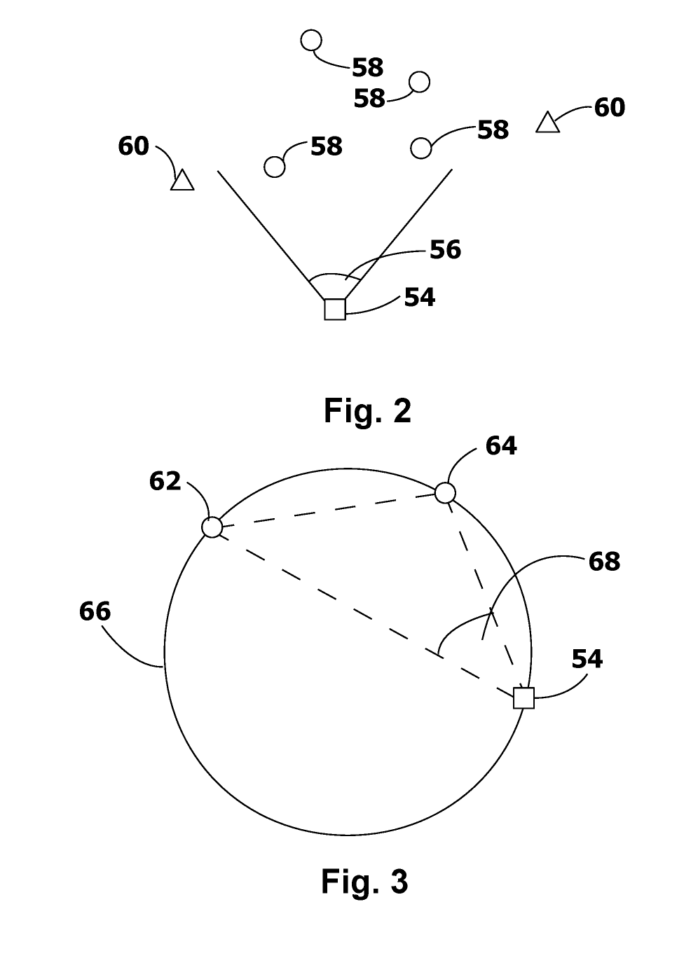

In FIG. 2 there is shown schematically a camera 54, designated by a square. The camera 54 is having a certain FOV represented by an angle 56. The camera 54 is mounted on a UAV, not shown. Landmarks 58 are designated by circles and are within the FOV of the camera 54 while landmarks 60 designated by triangular are out of the camera's FOV. The following describes the situation with two-dimensional plane, so all objects, including the UAV/camera, are projected onto the plane of the ground. The UAV is flying above ground, but the projection on to the ground is possible by means of transformations such as use of Euler angles. Inputs for this are the three angles associated with the UAV rotations with respect to the earth coordinates, and the two angles associated with the camera rotations with respect to the UAV. Errors in the measurements of the angles are expected to be partially canceled since differences of absolute angles are what the method uses for calculation the UAV self-geo position.

Referring to FIG. 3, the method of the present invention is partially based on work dating back approximately 2300 years, to Euclid. If the UAV's camera 54 optically detects two landmarks 62, 64, as long as the UAV and the two landmarks 62, 64 do not line on a straight line, not collinear, all three lie on a circle 66. If the inscribed angle 68 is measured from the UAV to the two landmarks, whose positions are known from a map, the circle 66 is determined fully. The algorithm is known, for the equation of the circle 66, center and radius. Thus, for two landmarks 64, the position of the UAV's camera 54 must lie on the circle 52 which has been completely determined.

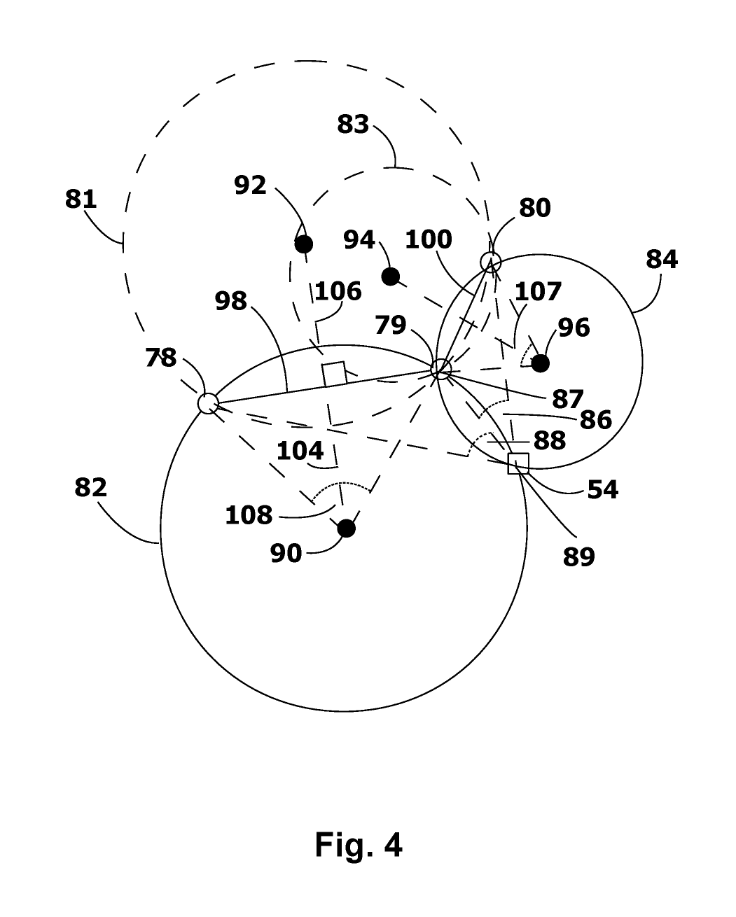

Referring now to FIG. 4, for three landmarks 78, 79, 80 three circles are now determine and the UAV must lie at one of the three intersections of the three circles (circle 82, circle 84 and the third circle which is not shown). Often, one of the intersections, for example intersection 87 may be rejected as not being physical or realistic. Due to errors in the measurement of the inscribed angles, for example, inscribed angles 86 and 88, the circles 82 and 84 will have errors and the intersections will be in error (for example intersections 87 and 89). This leads to error in the determined UAV position (CEP). Addition of further landmarks in the measurement process will in general increase the accuracy. It is possible to check the accuracy of the method for example by use of Monte Carlo simulations over numerous trials for specific geometries. The inaccuracy in the included angle is given by the standard deviation, σ, with the error drawn from a Gaussian distribution. The inaccuracy on the included angle will be after the rotations through the five angles mentioned. It was found that the algorithm developed converged to the true UAV position when the value of σ was set to zero. This technique was followed to obtain the error in the result.

As mentioned above, the method in accordance of the present invention uses at least three landmarks to find the UAV position in the plane, which can be looked at as three pairs of circles. In FIG. 4, two out of the three pairs of circles are shown first pair 84, 83 and second pair 81, 82. In general, the more landmarks used, the better will be the accuracy. Additional landmarks will remove ambiguity. Each pair of landmarks defines two circles, and we can often assume that only one of these circles is relevant and the other can be discarded. If we cannot discard one of the circles, then we can continue to work with both circles and remove one using additional landmarks. If we have retained one circle, we can use another pair of landmarks in a similar fashion to find another two circles, where we can again often discard one of the circles. In FIG. 4 the dashed line circles are the circles which can be discarded.

To summarize up to this point, if we have three pairs of landmarks, we have six circles generated, and often we can discard one, two or three of these circles. Thus, we can often be left with three circles generated by the three pairs of landmarks. Once again, the three pairs of landmarks may actually be three landmarks which are three pairs. Assuming we have only two circles for example circles 84 and 82 from the previous explanation; we can find the intersection of these two circles, one of which is the true geo-position of the UAV/camera. Often, we can discard one of these intersections as being unrealistic, leaving us with the true position. More landmarks can remove the ambiguity.

The following is an exemplary description, in outline form, of the method used to find the definition of a circle, for instance circle 82 when the UAV measures the inscribed angle to two landmarks, for instance landmarks 78 and 79 while looking from the UAV. We assume a plane geometry for this discussion. We also assume the geo-positions of the landmarks are known from a map and comparison of the camera 20 video image to a map, using proper software, all this with a given accuracy.

As mentioned we plan to measure the inscribed angle for instance, the inscribed angle 88 by direct use of the image, without necessarily rotating the camera. The optical system may be calibrated to reduce or eliminate systematic errors. When this is done, transverse distance in the image, which can be measured by counting pixels in the image, is equivalent to measurement of the inscribed angle. Again, we also plan to calibrate the lens so errors are minimized.

The following are steps leading to finding the circles. In fact, we will find two circles as mentioned above. A circle is defined by the center of the circle and the radius so we need to find these two values. In Fig.4 the black filled circles 90, 92, 94 and 96 are the center of circles 82, 81, 83 and 84 respectively. We can visualize finding the center of the circle and the radius and then proceeding to draw the circle on the map. There are two pairs of circles for a pair of landmarks which satisfy the following development. We assume there is some general prior knowledge as to the location, based on some inaccurate knowledge, such as a general video image, dead reckoning, etc. Thus, assume one of the circles can be discarded as not being reasonable, for example, being in the wrong direction. If this is not possible, such as when the circles are too close, it is possible to work with both circles and resolve the ambiguity by using more information, further sets of landmarks, for example.

In FIG. 4, there is shown an exemplary of two pairs of circles 82, 81 and 83, 84, in each pair one is drawn in dashed line 81, 83 and the other one is drawn in continuous line 82, 84. Landmarks 78 and 79 are lie at the ends of the chord 98. Landmarks 79 and 80 are lie at the ends of the chord 100. The inscribed angle measured from every point on each of the two circles 81 and 82 to the ends of the chord 98 is the same. The radius is the same for both circles 81 and 82 as well. The two circles 81 and 82 lie on either side of the chord 98. Again, often one of the circles may be discarded. In the example shown in FIG. 4 the dashed circle 81 is discarded. The inscribed angle measured from every point on each of the two circles 83 and 84 to the ends of the chord 100 is the same. The radius is the same for both circles 83 and 84 as well. The two circles 83 and 84 lie on either side of the chord 100. Often, one of the circles may be discarded. In the example shown in FIG. 4 the dashed circle 83 is discarded.

For example, consider the two landmarks' coordinates 78 and 79 that lie on the circle 82. The circle 82 on which the camera ground position might be is to be determined by the module for calculating camera geo-position 47. A line between the two landmarks defines the chord 98 of the circle 82. The two sets of landmarks' coordinates 78 and 79 are the end points of the chord 98. We can think of drawing the chord 98 on the map when we have the coordinates of the landmarks. A perpendicular line 104 is drawn to the chord 98, falling through the center point of the chord 98. We can think of drawing this perpendicular line 106 on the map and can always be done given the location of two landmarks. The center of the desired circle must lie on this perpendicular line and only one circle 82 from the pair of circles 82 and 81 is retained. We can visualize that the center of the circle must lie on the perpendicular line 106 on the map. The circle which is retained is shown in continuous line. Both circles 82 and 81 are generated by the same pair of landmarks, shown as smaller circles 78, 79 and the same inscribe angle 88. From geometrical construction, if two inscribed angles intercept the same arc, then the angles are equal. In addition, the inscribed angle theorem states that an angle θ inscribed in a circle is half of the central angle 2θ that subtends the same arc on the circle. Therefore, the inscribed angle does not change as its vertex is moved to different positions on the circle. In particular, for our case, moving the vertex to different positions on the circle is equivalent to possible positions of the UAV, one of which is the correct position. For example in our case center angle 108 is twice the inscribed angle 88.

When the two landmarks are identified on the map the length of the chord can be easily computed and the midpoint of the chord on the map and the perpendicular from the chord center can easily be drawn. Since we have the inscribed angle as an input by counting pixels in the image to find the included angles of two landmarks in respect to the camera, the central angle is known as double the inscribed angle. It is easy to find a point located on the perpendicular line which has an angle to the two landmarks equal to the computed central angle. As we have seen, there are two such points along the perpendicular line as shown in FIG. 4. These two points are candidates for the center of the circle. We can often discard one of them, as mentioned above. Once this is done we have the center of the circle and the radius, as given from the center of the circle to either one of the two landmarks. Once we have generated two retained circles for example 84 and 82, we can find the two intersections of these circles. Often only one of the intersections is declared viable and this is declared to be the true position of the UAV.

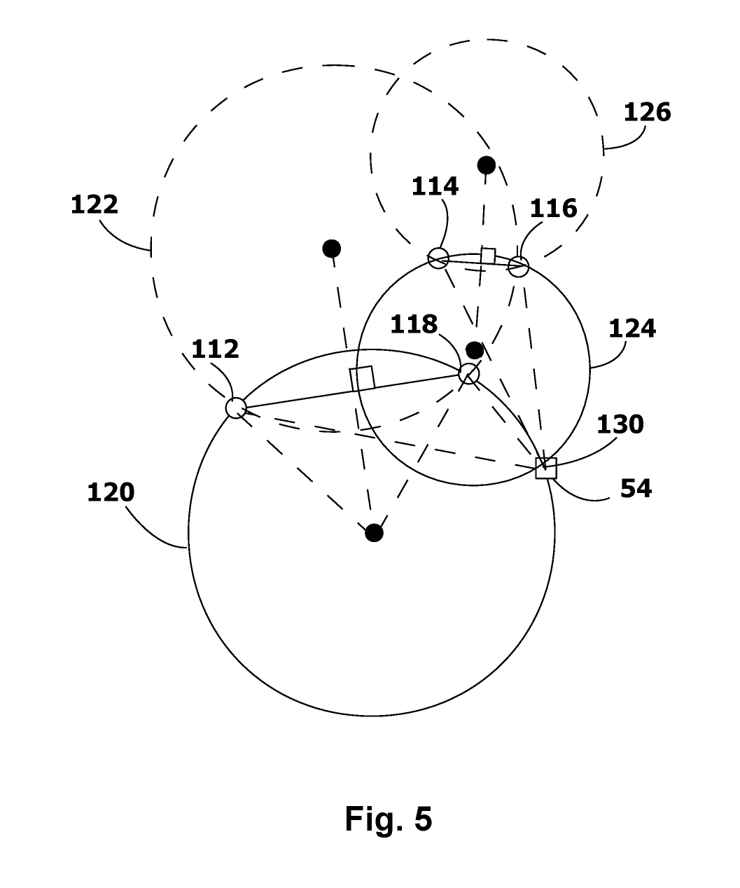

Referring now to FIG. 5 there is shown four landmarks 112, 114, 116 and 118. From four landmarks six pairs of circles can be determined as described above. In FIG. 5 only two pairs out of the six circle pairs are shown. The first pair includes circles 120, 122 and the second pair includes the circles 124 and 126. The dashed line circles are the circles that can be omitted as it is not possible that the UAV 54 will positioned there and on the continuous line circles 120, 124 are the possible positions of the UAV, one of which is the correct position. In our case the circles 124 and 120 intersect in points 130 and 132 where the circles intersection 130 is the correct position of the UAV 54.

In accordance with one embodiment of the present invention the use of a wide-angle lens with large field-of-view will avoid rotating the lens to measure the inscribed angle to the landmarks. This will reduce the error in determining the angle. It is therefore unnecessary to measure absolute angles as included angles are measured directly. This method should lead to faster measurement since there is no need for mechanical movement of the camera optical system. The UAV will have a single orientation during the measurement process which is an advantage.

In accordance with another embodiment of the present invention the lens and system is intended to be calibrated for each system. Thus, there will be a one-to-one mapping between differential pixel count in the digital image as a function of position in the image and the included angle. This will allow more direct measurement of included angle. Digital pixel counting leads to measurement of included angle.

In accordance with another embodiment of the present invention there can be pre-flight preparation and planning where a bank of landmarks is prepared in advance in order to assure high accuracy in positioning. This bank of landmarks is prepared using simulation software to choose the landmarks.

In accordance with another embodiment of the present invention simulations is performed for typical UAV orientations, to determine, if the 3D angles are used instead of the angles in the 2D geometry, the errors will be small enough to neglect the transformations.

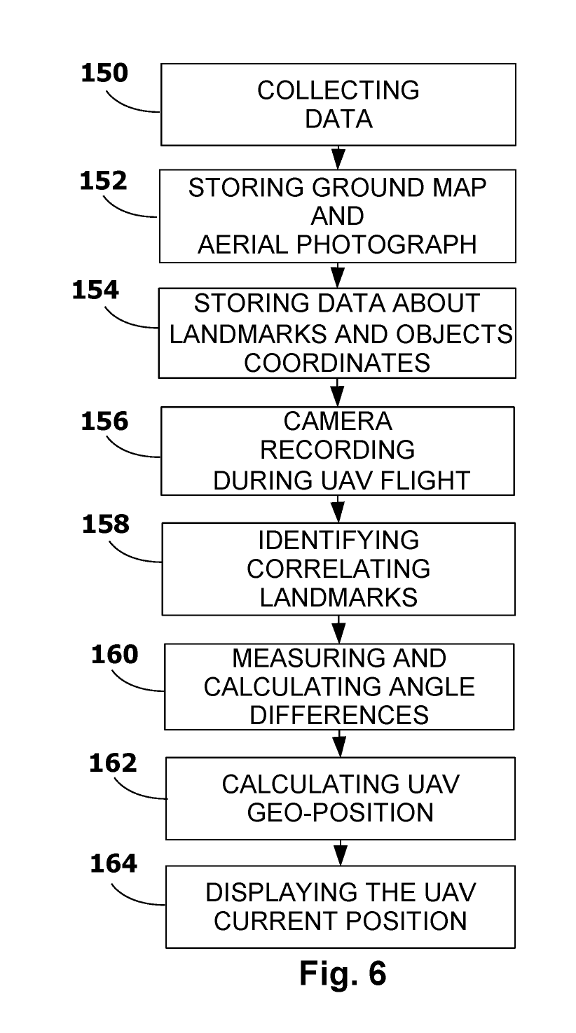

Referring now to FIG. 6, the following steps describe the method for computing the global position of a UAV in accordance with some embodiments of the present invention. In step 150, to reduce error and increase accuracy of the UAV position in step 150 the method may collect data from the altimeter sensor about the altitude of the UAV. In step 150 the method may also collect data from inertial navigation system to continuously calculate via dead reckoning the position, orientation, and velocity (direction and speed of movement) of the UAV position. In step 150 the method may also collect data about the past history of the flight (for example by applying a Kalman filter module) for the UAV position accuracy, reducing error and remove UAV position ambiguity. In step 152 an accurate map and/or aerial photography of the ground region is stored in the memory 14. In step 154 data about coordinates of objects and landmarks in the map region and/or in the aerial photography region is stored in memory 14. In step 156, camera recording during the UAV flight images and streaming video that can be stored in the memory 14 and can be processed in real-time. In step 158 identifying and correlating objects/landmarks seen on the field-of-view (FOV) of the UAV 20, with objects/landmarks on the accurate map region and/or aerial photograph region. In step 160 measuring and calculating angles differences, measuring the included/inscribed angles within the camera's FOV by counting pixels in the image for finding the included angles of two landmarks in respect to the camera. Preferably, the angle differences measuring are measured/calculated without orienting the camera. In step 162, calculating camera geo-position by the module for calculating camera geo-position as described above. In step 164, displaying the current position of the UAV during the UAV flight for example the landmarks and the calculated position/coordinates of the UAV on a map, data and/or on aerial map/photography of the ground region.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A method for self-geoposition an unmanned aerial vehicle (UAV), said system comprising the steps of:
storing in a memory accurate map and/or aerial photography of a ground region giving the coordinates of objects and landmarks;
camera recording during said UAV flight, images and streaming video that is stored in said memory and processed in real-time;
identifying and correlating objects and landmarks seen on the field-of-view of UAV's camera with objects and landmarks on the accurate map region and/or aerial photograph region;
measuring and calculating angles differences, measuring included/inscribed angles within the camera's FOV by counting pixels in the image of said camera for finding the included angles of pairs of landmarks in respect to said camera;
calculating the self-geo position of said camera by using said landmarks position and said included/inscribed angles;
displaying the current position of said UAV during the UAV flight.

2. A method according to claim 1, wherein to reduce error and increase accuracy of the UAV position said method further comprising the step of collecting data about the altitude of the UAV from an altimeter sensor.

3. A method according to claim 1, wherein said method further comprising the step of collecting data from inertial navigation system to continuously calculate via dead reckoning the position, orientation, and velocity of said UAV position.

4. A method according to claim 1, wherein said method further comprising the step of collecting data about the past history of said UAV flight by applying a Kalman filter module for said UAV position accuracy and removing UAV position ambiguity.

5. A method according to claim 1, wherein said angle differences measuring are measured/calculated by orienting said camera if there isn't enough landmarks in said FOV for determining the accurate position of said UAV.

6. A system for self-geoposition an unmanned aerial vehicle (UAV), said system comprising:
a memory for storing an accurate map data and/or an aerial photography of a ground region, said memory further stores data about coordinates of objects and landmarks in said map region and/or in said aerial photography region;
a camera mounted on said UAV and is able to record in real time or during the UAV flight images and streaming video stored in said memory;
a landmarks/objects correlation module which uses methods and techniques for identification and association/correlation of objects/landmarks optically detected on the field-of-view (FOV) of said camera, with objects/landmarks in said map region and/or in said aerial photography region;
angles differences measuring module, measures included/inscribed angles within said camera's FOV by counting pixels in the image of said camera to find the included angles of pairs of landmarks in respect to said camera;
a camera geo-position calculation module for calculating the self geo-position of the UAV by using said landmarks position and said included/inscribed angles;
a display to display said landmarks and said calculated position/coordinates of said UAV on a map data and/or on aerial map/photography of said ground region.

7. A system according to claim 6, wherein said system further includes an altimeter to measure the altitude of said UAV.

8. A system according to claim 6, wherein said camera records are transmitted to a ground control station.

9. A system according to claim 6, wherein said system further comprising means for orienting said camera, for obtaining said angles when said camera is pointing to a specific region and then to rotate said camera to a new pointing region and re-measure said included angles of pairs of landmarks in respect to said camera.

10. A system according to claim 6, wherein said system further comprising a Kalman filter module for collecting data about the past history of said UAV flight by applying said Kalman filter module and in order to improve said UAV position accuracy and removing UAV position ambiguity.

11. A system according to claim 6, wherein for wider FOV requirement for better UAV position accuracy said system further comprising a wider FOV lens selected from a group of fish-eye lens and two camera lenses at a permanent fixed angle.

12. A system according to claim 6, wherein said included angles are to be measured in the plane of the flat earth model, that is, parallel to the surface of the earth, in the 2D geometry to be found from the 3D angles by transformations and sensors.

13. A system according to claim 6, wherein said system further comprising camera gimbal mount to allow said camera to remain upright with respect to the horizon despite the UAV's pitching and rolling using gyroscopes as an aid in directly measuring said included angles.

14. A system according to claim 6, wherein said system further comprising onboard navigation equipments that are used to remove ambiguities regarding the true position of said UAV and improve accuracy including fusing of data.

15. A system according to claim 6, wherein said optically detected pair of landmarks and said UAV are not collinear and all three lie on a circle defined by said pair of landmarks and said inscribed angle; the inscribed angle is measured from said UAV to a pair of landmarks by said angles differences measuring module; a pair of circles is determined and one of said circles is the circle where said UAV is lie on; to determine the self-geoposition of said UAV/camera, at least three landmarks which are optically detected are required;
Thereby, three pairs of circles are now determine; on one of the circles of each pair, said UAV must lie on;
wherein, one of the intersection points determined by the three circles where said UAV lie on is the true position of said UAV and wherein one or more of said intersections points is rejected as not being physical or realistic.

16. A system according to claim 15, wherein the more pair of landmarks optically detected and used to determine said UAV's self geo position, the better will be the UAV position accuracy and additionally there will be less ambiguity regarding said UAV's self geo position.
